(19) United States
(12) Patent Application Publication
(10) Pub. No.: US 2025/0050204 A1
(43) Pub. Date: Feb. 13, 2025

(54) SYSTEMS AND METHODS FOR CLIENT-SERVER DISPLAY TIMING

(71) Applicant: Ivan Svirid, Vaughan (CA)

(72) Inventor: Ivan Svirid, Vaughan (CA)

(21) Appl. No.: 18/446,453

(22) Filed: Aug. 8, 2023

(51) Int. Cl. A63F 13/358; A63F 13/355; G06F 3/14; H04L 65/80; H04N 7/088

(52) U.S. Cl. CPC A63F 13/358; A63F 13/355; G06F 3/14; H04L 65/80; H04N 7/088

(57) ABSTRACT

Systems, apparatus, and methods for performing client-server display timing. A client device may synchronize frame rendering frequency on a server with a client device display frame rate. The server may render frames at the rendering frequency and send the frames to the client device. The client device may determine whether frames were received at a nonoptimal time window and send a pacing message to the server to offset frame rendering. The server may offset the timing of rendering/sending the frame to the client device based on timing data of previous frames at the client device. Frames generated at the server may arrive during an optimal timing window for reduced latency.

### RELATED APPLICATIONS

This application is related to U.S. patent application Ser. No. 17/813,929 filed Jul. 20, 2022, and entitled “Systems and Methods for Reducing Display Latency” incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of graphics applications. More particularly, the present disclosure relates to systems, computer programs, devices, and methods for improved client-server display timing.

### DESCRIPTION OF RELATED TECHNOLOGY

Latency is a time delay experienced by a system. Two types of latency may include input-to-display latency and network latency.

Network latency (also known as “network lag” and “network delay”) refers to the delay in data communication as the data travels over a network. This type of latency is experienced by a user of a system as data is transmitted from a one device across a network to another device. Delays may occur due to processing, queuing, and transmission delays of network devices or propagation delays through network media.

A user may experience network latency, for example, when playing an online game the game state may be stored on a server for use from multiple players. When a user takes an action in the game, data is transmitted from the user's device over a network to a server for processing and a result or updated state is transmitted back over the network from the server to the user device where the user device can process and display the updated game state to the user. Significant network latency may cause extensive desynchronization between of the game state of the server and on the user device. The consequences of such desynchronization may be a user viewing an outdated or incorrect game state, freezing or unresponsive gameplay, game state rollbacks, sluggish or unresponsive controls, etc.

Designers of client-server game systems may introduce compensation schemes on the client-side to manage latency. Such schemes may include extrapolation techniques that estimate a future game state (which is updated when new game state information is received from the server) and interpolation techniques that buffer the game state to smooth transitions of the game state.

Input-to-display latency (also known as “display latency” and “input lag”) is a type of latency experienced by a user of a system from the time the user enters input (e.g., a button press on a mouse/keyboard, joystick on a handheld gaming controller, voice command to a microphone, visual information to a camera, various sensor inputs, etc.) for the signal to be processed and to show the results of that input on the display. This delay may be measured in milliseconds or by display frames shown.

In many use cases, the user experience degrades as latency increases. For example, imagine a user signing their name on a tablet but a significant delay exists between when they touch their finger or stylus to the touch screen display and the line appearing on the screen. The user may alter their signature in response to not receiving immediate feedback of their input.

The experience is also felt acutely in video gaming where a user experiences their character moving through the world as though they are walking through molasses and taking actions (use an item, interact with the environment) takes a noticeable amount of time to play out on screen. In some virtual/augmented reality applications, a user may develop “cybersickness,” which can create symptoms including disorientation, apathy, fatigue, dizziness, headache, increased salivation, dry mouth, difficulty focusing, eye strain, vomiting, stomach awareness, pallor, sweating, and postural instability in a user. Latency, including input-to-display latency, can contribute to cybersickness in these applications.

In an ideal environment, latency is non-existent and a user can experience no processing/display delay as if they were having a seamless experience in the “real world.” Of course, latency is impossible to eliminate as propagation delays (from the input device) to the processing device, processing delays of the input, and delays in rendering/displaying the changed environment cannot be completely eliminated. Minimization of that delay to the greatest extent possible, goes a long way to providing the end user a natural user experience and reducing the causes of cybersickness.

Users may try and improve latency by improving the hardware specifications of their computer devices. A display with a faster refresh rate (e.g., 90 or 120 Hz over 60 Hz) and faster processing (at the CPU or GPU) to improve latency. Using a hardwired network connection over wireless technologies as well as improved service performance of the network connection (through increased bandwidth/throughput, reduced “ping” or network latency) can also improve input latency in networked/online environments where added delay occurs from the network connection.

Certain televisions have a “gaming mode,” that when used will bypass one or more video signal processors in the TV cutting down the amount of time the television needs to process video input from a video game system. There may, however, be a noticeable drop in video quality (e.g., an increase in noise, decrease in contrast, a less sharp image, muted colors, etc.) due to the bypassed processing, but with an improvement in latency and responsive and a reduction in the display pipeline.

### BRIEF DESCRIPTION OF THE DRAWINGS

FIG. 1 illustrates an exemplary graphical user interface (GUI) application stack, useful in conjunction with various aspects of the present disclosure.

FIG. 2 illustrates a client-server environment with a ladder diagram describing interactions between devices according to aspects of the present disclosure.

FIG. 3A illustrates a flow diagram of an exemplary client application according to aspects of the present disclosure.

FIG. 3B illustrates a flow diagram of an exemplary server application according to aspects of the present disclosure.

FIG. 4 illustrates an exemplary timing diagram of frames received by an exemplary client device and an exemplary timing graph of a timing offset on an exemplary server, according to aspects of the present disclosure.

FIG. 5 is a logical block diagram of a client device, according to aspects of the present disclosure.

FIG. 6 is a logical block diagram of a server, according to aspects of the present disclosure.

FIGS. 7A-7D illustrate exemplary memory subsystems of a server to control timing and frequency of frame rendering, according to aspects of the present disclosure.

### DETAILED DESCRIPTION

In the following detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

### Overview

Internet-enabled applications, remote desktops, cloud-based gaming, and other types of computer software may experience latency based on a number of different factors. Especially when communicating over a network connection, such latency may result in a diminished user experience, especially when aspects of an application are latency dependent (e.g., cloud gaming or remote desktop applications). In a conventional relationship between a server and a client device, the server is rendering frames to send to the client device, the timing of when the frames are sent by the server may affect display latency experienced on the client device. This may especially be a problem if the timing of frame rendering on the server side does not match timing on the client side. For example, without limitation, the server may render frames too quickly or too slowly such that the frames may arrive at the client at a suboptimal time. Receiving frames at a suboptimal time may result in presentation of the frame by the application on the client device and/or display of the frame by the client device that causes the frame's display to be delayed or skipped degrading the user experience.

According to aspects of the present disclosure, frame timing is coordinated between the client device and the server. In some examples, the client device may coordinate timing with the server by coordinating the number and frequency of frames being sent by, e.g., sending to the server a display frequency. Additionally, the optimal time to receive a frame from the server may be as close as possible to the next scanout time or internal presentation deadline so the frame will be able to be displayed at the next available scanout. The client can also send a message to the server to offset its timing of rendering/sending the frame so that the frame arrives at approximately the optimal time.

In a graphical application where the application generates/renders and presents frames for display, the optimal timing for frame presentation just before the presentation deadline, this ensures a smooth experience, no frames get skipped. Strategies for frame presentation timing are discussed within U.S. patent application Ser. No. 17/813,929 filed Jul. 20, 2022, and entitled “Systems and Methods for Reducing Display Latency” previously incorporated by reference in its entirety.

In a client device-server environment (e.g., a cloud gaming, remote desktop, or other streaming environment) the frames are produced remotely by the server and the sooner the frames are received and displayed by the remote application on the client device the less delay will be experienced by the user providing a better user experience. In one exemplary scenario, a remote application running on a server generates frames and a client device that receives and displays the frames rendered by the remote application on the server. The display of the client device is running at a certain frequency (the framerate) that is not necessarily equal to the frequency the remote application running on the server is rendering frames. There is therefore a need for solutions that (1) synchronize the client display of the frame to the server application render, (2) offsets the timing of sending the rendered frame by the server to the client device, (3) offsets the timing of when the server starts to draw/render the frame, and/or (4) synchronizes the client device and server by the sending signals from the client device instructing the server to offset the timing of rendering/sending the frame to the client device. According to aspects of the present disclosure, these frequencies may be brought inline and then the timing of rendering/sending the frames may be shifted on the remote application on the server on demand to be as close to the client frame receipt deadline as possible.

Timing information may be sent to a remote application on the server to ensure the frames arrive at the client before the presentation/scanout deadline. For example, if a frame arrives at a suboptimal time with respect to the deadline (e.g., just after the deadline), a message is sent by the application on the client device to the remote application on the server to skew the next frame timing for all future frames.

### Operating Environment

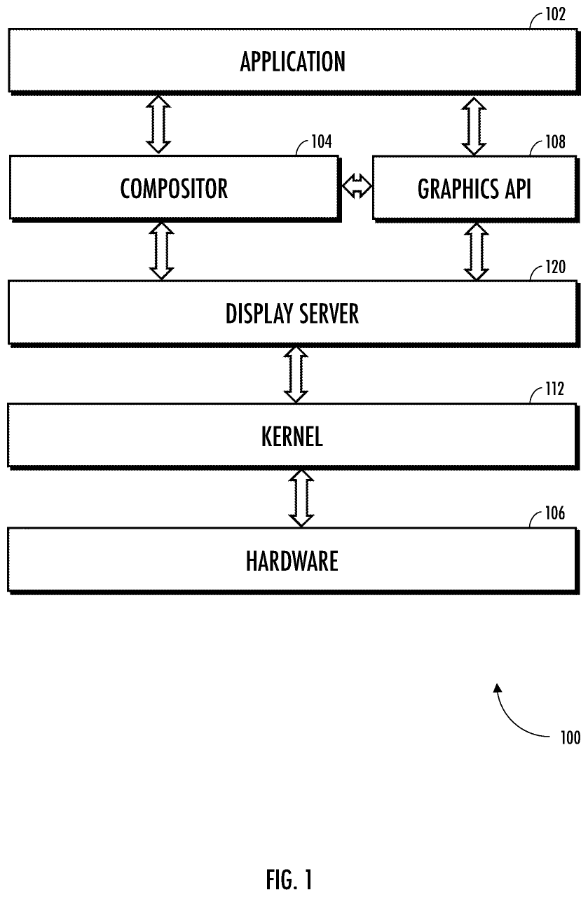

FIG. 1 illustrates an exemplary graphical user interface (GUI) application stack 100 for an application 102 to explain causes of processing delay. Exemplary GUI application stack 100 is a software stack to manage a GUI for a computer system. The exemplary GUI application stack 100 may run on the client device 204. The GUI application stack 100 provides a platform that applications, including application 102, may access computer hardware 106 (including, e.g., CPU, GPU, display). The GUI application stack 100 includes a compositor (composited window manager) 104.

Other GUI application stacks, both simpler (without certain layers, e.g., without using a compositor 104) and more complex (with additional, or different, layers), may be used with the disclosed techniques with equal success, each adding differing amounts of processing delay. For example, in some exemplary embodiments, some devices bypass middle layers of the application stack (e.g., compositor 104) to decrease processing delay. This may occur where an application is full screen and other GUI elements are not needed or where frames are not rendered by the device (and, e.g., are rendered on a separate device and received via a network).

The GUI application stack 100 includes an application 102 in communication with a compositor 104. The application 102 may receive user input and calculate or update information based on the received user input. The application 102 may cause the calculated or updated information to be displayed. The application 102 may not draw directly to the display. To display information, application 102 is configured to store information in a buffer or temporary storage for sampling and manipulation by the compositor 104. In some examples, the buffer or temporary storage is a frame buffer. In some examples, the application 102 does not move data directly onto a frame buffer and instead the data for display is stored in compositor specific buffers. The application 102 may send commands to the hardware 106 to draw to the display. For example, the application 102 may send commands to a GPU for processing and display, in conjunction with the compositor 104, via the graphics API 108.

The kernel 112 is a computer program at the core of a computer's operating system and has control over the hardware 106. The kernel 112 is the highest privileged portion (unrestricted) of the operating system. Applications are granted privileges to access system resources (restricted access). Some operating systems use a simple 2-privilege system, others use more complex arrangements (e.g., read/write/execute specified for user, group, everyone). Application 102 may access the hardware 106 via APIs that are exposed by the kernel 112. The kernel 112 is the portion of the operating system code that facilitates interactions between the hardware 106 and software components including the application 102, the compositor 104, the graphics API 108, and display server 120. In some examples, kernel 112 is always resident in memory. The kernel 112 is configured to control hardware resources (e.g., I/O, memory, processing hardware/GPU) via device drivers, arbitrates conflicts between processes concerning such resources, and optimizes the utilization of common resources, e.g., CPU and cache usage, file systems, and network sockets.

The kernel 112 may also access network resources (e.g., a network interface) in hardware 106. Network resources may be used to send and receive data from devices connected via a network connection. This data may include configuration data, image data (e.g., frames or partial frames), or state information (application state information, user input, etc.). The application 102 may process this data and/or present this data for display by the hardware 106.

In rendering a frame for display, input latency occurs due to the time the application 102 takes for receiving/processing the input, updating the application environment, and rendering the new frame. In a remote rendering environment, rendering a frame for display, latency may also occur due to the time the application 102 takes for receiving/processing the input, updating the application environment, sending the input and environment data to a server (e.g., server 202). Latency may occur in the network delay in sending the data from the client device to the server. Latency may occur at the server to receive and process the input/environmental data from client device, rendering the new frame, and sending the new frame to the client device. Further latency may occur in the network delay in sending the new frame from the server to the client device. Further latency may occur at the client device (including at the application 102) to receive and process the new frame for display and displaying the new frame on the client device.

Rendering a frame initiates a multi-stage pipeline process (the graphics pipeline). Pipeline processing refers to a technique for implementing instruction-level parallelism and attempts to use multiple parts of a processor during a complex operation by overlapping operations by moving data or instructions into a conceptual pipe with all stages of the pipe performing simultaneously. For example, while one instruction is being executed, the processor is decoding the next. The multi-stage pipeline does not only include the standard image processing/graphics pipeline (that includes vertex specification, vertex processing, rasterization, fragment processing, and per-sample culling operations) but also includes data movement and processing operations of the compositor 104 and display server 120. Such operations may cause a noticeable delay of a few frames in processing data through the pipeline over serial (non-pipelined) operation.

A frame buffer (also known as a framebuffer, framestore, or display buffer) is a portion of random-access memory (RAM) in hardware 106 containing a bitmap that drives a video display. A frame buffer is a type of memory buffer containing data representing all (or substantially all) the pixels in a complete video frame. GPU hardware is configured to convert an in-memory bitmap, stored in the frame buffer, into a video signal that can be displayed on a display.

A frame buffer may be designed with enough memory to store two frames of video data. In a technique known as double-buffering or page flipping, the frame buffer uses half of its memory (a primary buffer) to display the current frame. While that half of the frame buffer memory is being displayed, the secondary/other half of frame buffer memory is filled with data for the next frame. Once the secondary buffer of the frame buffer is filled, the frame buffer is instructed to display the secondary buffer instead. The primary buffer becomes the secondary buffer, and the secondary buffer becomes the primary. This switch is often done after a vertical blanking interval to avoid screen tearing where half the old frame and half the new frame is shown together.

Many displays today have a rolling scanout (also called a raster scan), rather than global scanout. This means that the pixels are updated line by line rather than updated all at once. A vertical blanking interrupt may signal the display picture has completed. During the vertical blanking interval, the raster returns to the top line of the display. The display hardware generates vertical blanking pulses. Some display technologies also use horizontal blanking intervals (new line, raster returns to start of new line).

The frame buffer is a type of memory from which the hardware 106 writes to the display. In contrast, a swap chain (also known as a screen buffer, video buffer, or off-screen buffer) is a part of memory used by an application 102 for the representation of the content to be shown on the display. The swap chain may also be a buffer that is written to by the application 102 during graphics processing. Data in the swap chain may be read and manipulated by the compositor 104. The compositor 104 may output frames for display to the frame buffer which the hardware 106 can scanout for display. In some examples, however, frame data (output by the application 102) may be written directly from the swap chain to the display.

In a specific implementation, application 102 may place frames/images on a swap chain. A swap chain is a collection of buffers that are used for rendering and displaying frames. Each time the application presents a new frame for display, the first buffer takes the place of the displayed buffer. This process is called swapping or flipping. In some examples, when application 102 draws a frame, the application 102 requests the swap chain to provide an image to render to. The application may wrap the image in one or more image view and/or a frame buffer. An image view references a specific part of an image to be used, and a frame buffer references image views that are to be used for texture, color, depth or stencil targets. Once rendered, the application 102 may return the image to the swap chain for the image to be presented for display. The number of render targets and conditions for presenting finished images to the display depends on the present mode. Common present modes include double buffering and triple buffering. The swap chain may include multiple images/frames for rendering and drawing on the display.

In a double buffering example, the system may actively scanout a frame in a first display buffer in an active state while a second display buffer in an inactive state is able to receive information about the next frame for future display. Once the frame has been drawn, a period of time elapses or a command is executed, the first buffer “flips” and becomes inactive, and the second buffer becomes active. The next frame stored in the second buffer is scanned out to the display. The first buffer (now inactive) is once again available to receive information about a future frame for future display from the application. Frame data for scanout may be received by the display buffers by the compositor.

In a triple or higher-order buffer example, scanout may shift between three (or more) buffers. In certain situations, triple-buffering may improve throughput (resulting in less stutter) if the GPU has not completed rendering a frame when the buffer is set to shift and/or VSync indicates the frame has completed scanout and the buffer shifted. Rather than not shifting the buffer, as would occur in a double-buffer scenario, and waiting for the rendering operation to complete (adding an entire frame of delay), the scanout buffer may shift to the third buffer where anther generated frame may be drawn to the display.

The information in the swap chain and/or frame buffer may include color values for every pixel to be shown on the display. Color values are commonly stored in 1-bit binary (monochrome), 4-bit palettized, 8-bit palettized, 16-bit high color and 24-bit true color formats. An additional alpha channel is used in some embodiments to retain information about pixel transparency. The total amount of memory required for the screen and frame buffers depends on the resolution of the output signal, and on the color depth or palette size.

The compositor 104, also known as a composited window manager, provides applications 102 with an off-screen buffer for each window. As used herein, “compositing” and its linguistic derivatives refers to the overlay of multiple visual components. Compositing generally includes drawing task bars and other system wide user interface (UI) elements, combining/blending multiple application windows, applying a theme, etc. and other portions of the GUI application stack prior to display. The compositor 104 is configured to composite the window buffers into an image representing the screen and write the result into the display memory. The compositor 104 may be configured for drawing the task bar, buttons, and other operating system-wide graphical elements. The compositor 104 may perform additional processing on buffered windows, apply 2D and 3D animated effects such as blending, fading, scaling, rotation, duplication, bending and contortion, shuffling, blurring, redirecting applications, and translating windows into one of a plurality of displays and virtual desktops. The compositor 104 tends to introduce an extra layer of latency compared to applications that are able write directly to a frame buffer or display in hardware 106. The compositor 104 may apply visual effects to be rendered in real time such as drop shadows, live previews, and complex animation.

The compositor 104 obtains frames from an application 102 and uses the frames as a texture source to apply one or more overlaid effects. In some examples, the compositor 104 receives or accesses a frame presented or otherwise output by the application 102. Composited frames may be stored in a frame buffer. In some examples, the compositor 104 outputs identical (unchanged) pixel values to the frame buffer. The compositor 104 may include: Compiz, KWin, Xfwm, Enlightenment, Mutter, xcompmgr and picom in the Linux® operating system; the Desktop Window Manager in the Windows® operating system; the Quartz® compositor in macOS®; and SurfaceFlinger/WindowManager for the Android™ operating system.

Operating system-wide graphical elements may include a task/status bar, buttons, icons, widgets, text/fonts, menus, images and graphics, pointer/cursor, and animations/transitions. These elements may be based on a user customized or operating system default theme. The elements may be based on other settings such as the time of day or seasonal settings. For example, the color temperature or a dark/light mode of screen elements may be changed based on the time of day, e.g., between sunrise and sunset or between sunset and sunrise.

A graphics application programming interface (graphics API 108) may be an interface or library that communicates with graphics hardware drivers in the kernel 112 and/or compositor 104. APIs may be cross-platform (e.g., they can be implemented to work on a variety of operating systems/kernels and with a variety of hardware allowing for portable application code.) In some exemplary implementations, graphics API 108 may include an interface between rendering APIs and the platform windowing system. The graphics API 108 may include one or more implementations of OpenGL®, Vulkan®, Glide™, Direct3D®, DirectX®, and other graphics API specifications. The graphics API 108 interacts with the hardware 106 (e.g., a graphics processing unit (GPU)), to achieve hardware-accelerated rendering. Different graphics APIs may allow applications (such as application 102) different levels of access and control to the underlying drivers and GPU hardware. While presented examples may be in a high-level pseudocode or an implementation using an exemplary API, artisans of ordinary skill will understand, given the teachings of the present disclosure, the described concepts may be applied to a variety of operating environments.

To draw on a display, the application 102 may make one or more calls to the graphics API 108. In some examples, an instance of graphics API 108 may be created and physical devices (such as GPUs in hardware 106) may be selected by the application 102 that are controllable via the graphics API 108. Logical devices of the physical device may be created with associated queues for drawing and presentation (as well as other graphics, computer, and memory transfer) operations. Such operations may be performed asynchronously and/or in parallel. The application 102 may create/windows (e.g., a window, a window surface, etc.). The application 102 and graphics API 108 may communicate with the compositor 104 to perform windowing.

In a specific implementation, application 102 may place frames/images on a swap chain. A swap chain is a collection of buffers that are used for rendering and displaying frames. Each time the application presents a new frame for display, the first buffer takes the place of the displayed buffer. This process is called swapping or flipping. In some examples, when application 102 draws a frame, the application 102 requests the swap chain to provide an image to render to. The application may wrap the image in one or more image view and/or a frame buffer. An image view references a specific part of an image to be used, and a frame buffer references image views that are to be used for texture, color, depth or stencil targets. Once rendered, the application 102 may return the image to the swap chain for the image to be presented for display. The number of render targets and conditions for presenting finished images to the display depends on the present mode. Common present modes include double buffering and triple buffering. The swap chain may include multiple images/frames for rendering and drawing on the display.

The graphics API 108 may be called by application 102 to perform rendering operations on the images in the swap chain. Such operations may invoke the graphics pipeline and various shader operations on a GPU or other hardware (e.g., in hardware 106). A command buffer may be allocated with the applicable commands to draw the images/frames in the swap chain. The command buffer may include one or more operations to perform rendering, binding of the graphics pipeline, memory transfers, drawing operations, and presentation. These operations may be provided by a command pool and passed to the hardware 106 (including the GPU) using queues. As described previously, commands (and queues) may be executed asynchronously. Some exemplary APIs expose the application 102 to asynchronous functions performed by various hardware. The application 102 may use synchronization objects, e.g., semaphores and/or fences, to ensure the correct order of execution and to ensure that images being read for presentation are not being currently rendered. Other APIs may simplify timing management and hide asynchronous operations and the use of synchronization objects from the application.

The swap chain may include a number of different presentation modes. For example, in Vulkan®, there are four main presentation modes available. The first mode is VK_PRESENT_MODE_IMMEDIATE_KH—where images submitted by application 102 are transferred to the screen without delay (e.g., waiting for scan-out to complete). The second mode is VK_PRESENT_MODE_FIFO_KHR. In the first-in-first-out presentation mode, the display is refreshed from queued images stored in the swap chain. In one implementation, the display retrieves an image from the front of the queue when the display is refreshed and the application 102 inserts rendered images at the back of the queue. If the queue is full then application 102 waits. The third mode, VK_PRESENT_MODE_FIFO_RELAXED_KHR, is similar to the second mode but but additionally includes logic to handle situations where the application 102 is late to present a frame and the queue is empty at the last vertical blank. Instead of waiting for the next vertical blank (as would occur with VK_PRESENT_MODE_FIFO_KHR), the image is transferred right away when it finally arrives. This may result in visible tearing. The fourth mode is VK_PRESENT_MODE_MAILBOX_KHR does not block the application 102 when the queue is full; instead older images are replaced by new images.

VSync, or Vertical Synchronization/vertical sync, is a graphics technology that synchronizes the frame rate of an application (e.g., a video game) and a display's refresh rate. Synchronization may include limiting or stopping processing by an application or a GPU to match the refresh rate of a display. When active, VSync attempts to ensure that the display is in sync with the GPU and displays every frame the GPU renders by limiting the GPU's frame rate to the refresh rate of the display. VSync and related/vendor specific technologies such as Adaptive VSync, Fast Sync, Enhanced Sync, G-Sync, FreeSync, etc., have been used as a solution to resolve screen tearing. VSync limits the frame rate output by the graphics card to the refresh rate (e.g., 60 Hz, 90 Hz, 120 Hz) of the display, making it easier to avoid higher frames per second than the display can handle. VSync prevents the GPU from performing further operations in display memory until the display has concluded its current refresh cycle-effectively not feeding the display any more information until the display is ready to accept the data. Through a combination of double buffering and page flipping, VSync synchronizes the drawing of frames onto the display only when the display has finished a refresh cycle, so a user should not see screen tears when VSync is enabled.

Different hardware vendors have other (and in some cases improved) implementations of VSync-embodiments of the present disclosure contemplate disabling those vendor specific implementations as well. VSync forces frames to wait for the display to be ready, or to signal that the display is ready, which can contribute to input latency. More broadly, any firmware that forces frames to wait for the display to be ready (or signal that the display is ready) can contribute to display latency. This may take the form of locking a display buffer from swapping until the previous frame buffer has fully written before sending it to the display (to prevent e.g., tearing). VSync may be disabled to allow for the application to handle frame presentation and management which may allow the application to present frames/swap the buffer immediately/without waiting for the next vblank/within the current frame's time window (1/frame rate). In some examples, VSync also forces the application to use a full-rendering pipeline that is controlled/synchronized by the VSync signal. Disabling VSync may allow the application to break out of the requirements and timing of the render pipeline.

In some examples, VSync (e.g., a VSync setting), or other mechanism that limits the application/GPU to the display's refresh rate in order to synchronize the frame rate of an application with a display's refresh rate, may be disabled by a function call to the GPU (via an API call). A function call can be made to swap front and back frame buffers after waiting a specified number of vertical blanks. For example, a SwapInterval call may be made (e.g., glfwSwapInterval(0)) in OpenGL. A swap interval of 1 instructs the GPU to wait for one vblank before swapping the front and back buffers. A swap interval of 0 instructs the GPU that no delay waiting for a vblank is needed, thus performing buffer swaps as soon as possible when rendering a frame is complete, which may disable VSync. In other exemplary embodiments, the application selects a presentation mode with VSync disabled. In Vulkan, the presentation mode may be changed to “VK_PRESENT_MODE_IMMEDIATE_KHR” which specifies that the presentation engine does not wait for a vertical blanking period to update the current image. In other examples, a user may disable VSync after being prompted by the application to change settings (e.g., a VSync setting) in a control panel or via the command line.

With VSync or another GPU/application display limiter disabled, the application is not limited by the monitor refresh rate/vertical blanking to render and present frames. This allows the application to constantly render and present frames as fast as possible. Rendering and presenting frames as fast as they may be generated by the system may also create screen tearing.

In some examples, where a swap chain is present, “immediate” presentation mode may be used when disabling VSync. In those examples, when an application uses “immediate” mode VSync may be disabled. In some exemplary extensions to Vulkan, an asynchronous rendering mode may be used when disabling VSync.

The graphics API 108 may be called by the application 102 to perform one or more presentation operations. Presentation operations are the last step of rendering a frame by the application 102. In some embodiments, the frame is submitted to the swap chain to be drawn on the display (or output via a network). The graphics API 108 may direct the GPU or other hardware 106 to draw the frame on an integrated, connected, or networked display.

A display server 120 (also known as a window server) is a program in a windowing system configured to coordinate input and output of applications (e.g., application 102) to and from the kernel 112 (and rest of the operating system), the hardware 106, and other applications. The display server 120 communicates with its applications over a display server protocol.

In some embodiments, the functions of the compositor 104, graphics API 108, and display server 120 may be integrated into a single program, or broken up into two, three, or more, distinct programs.

Screen tearing is a display artifact such that a display displays portions of multiple different frames at one time. That can result in effects where the display appears split along a line, usually horizontally. Tearing typically occurs when the display's refresh rate (how many times the display updates per second) is not in sync with the framerate generated by the application 102. While screen tearing can occur at any time, it is most prevalent during fast motion, particularly when a game runs at a higher frame rate than the display can handle or when the frame rate changes dramatically and the display is unable keep up. Screen tearing is particularly noticeable during fast-paced games with vertical image elements, such as trees, entrances, or buildings. When this happens, lines in those vertical image elements noticeably fail to line up correctly, which can break immersion in the application 102 and make the user interface appear unattractive.

When a frame has finished displaying, VSync may alert the application 102 (via e.g., an interrupt) that the frame has finished displaying on the display. A blanking period may occur between frames being sent for display. The blanking period may last, in some examples, a half millisecond. The frame buffer “flips” between active and inactive buffers and the next frame will begin to display and the frame buffer will fill with new display data. As data sits in the other buffer waiting for the flip, that data stagnates (rather than being immediately presented for display) and as a result contributes to display latency.

### Example Operation

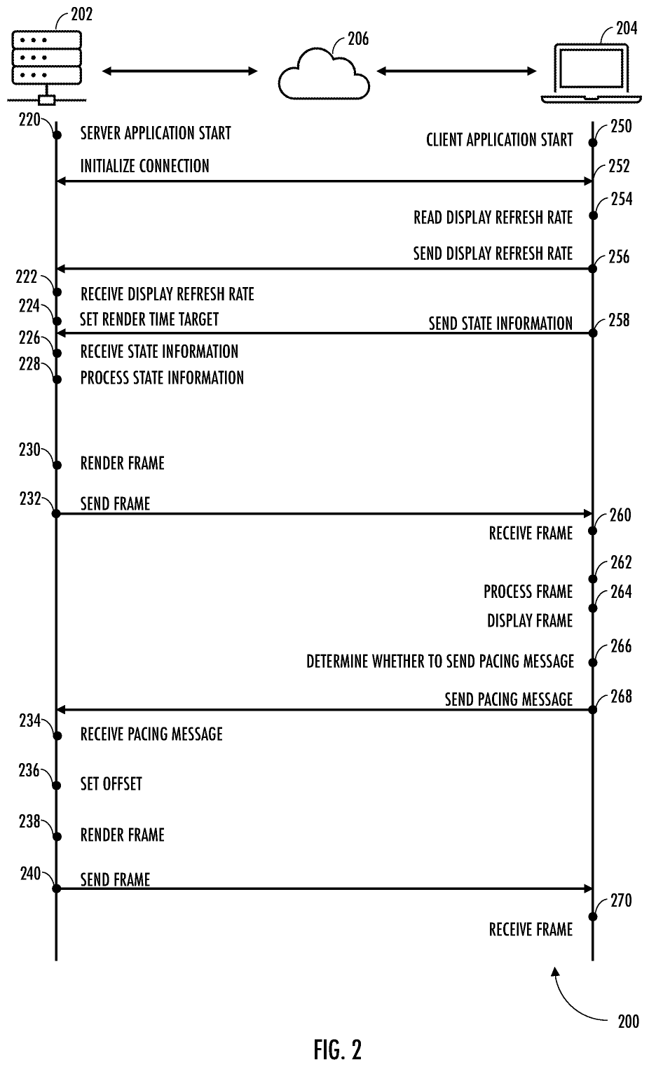

FIG. 2 illustrates a client-server environment 200 with a ladder diagram describing interactions between devices according to aspects of the present disclosure. For example, this client-server environment 200 may include a cloud gaming environment or a remote streaming environment where the source of the frames is created from one application running on a server 202 and streamed to a client device 204 via a network 206. The server 202 runs one or more server applications to maintain an application state, render frames, and send frames to a client device 204. The client device runs one or more client applications to receive user inputs and display frames received from the server 202. The ladder diagram illustrates an exemplary method for optimizing and maintaining frame synchronization between a server 202 and a client device 204.

In some examples, the client-server environment 200 is contained all within a single device. In this example, the server 202 is a server application and the client device 204 is a client application, where the server and client applications are separated by memory on a single device using a memory bus for communication (instead of, e.g., an external network). In other examples, the server application and client application are separated by a network 206 with the server application running on a cloud server that streams frames to a client application on a computer. For example, where the applications are client and server applications for a cloud-based game, the server application may run on cloud servers such as NVIDIA Cloud.

The client and server applications may be separated in other topologies/environments. For example, in a peer-to-peer (P2P) environment, a client device runs both a client application and a server application and connects to a second application that is run on a second client device, that does not run a server application, via a network (a local area network, the Internet, etc.). In another P2P environment, a single application acts as both a client application and a server application and run on a first client device that connects to a client application on a second client device.

In one example, the server 202 runs a server-side application for a graphical application (e.g., an online game, a remote desktop). The client device 204 may connect to the server to interact with the server-side application. The client device 204 may include a smart television, a virtual reality/augmented reality device, a mobile phone, a tablet, a smart watch or other wearable device, a laptop/desktop computer or virtually any device that is able to receive and display frames from a different device. The client device 204 may indicate a display refresh rate of a display of the client device 204. For example, the display refresh rate may be 30 FPS, 60 FPS, 90 FPS, 120 FPS, or a refresh rate that is faster or slower depending on the display used by the client device 204. Alternatively, the client device 204 may indicate a different refresh rate from the display refresh rate of the client device 204. For example, a slower rate may be selected due to a low bandwidth network connection.

The server 202 may begin execution of the server application (step 220). The server 202 may initiate an initial application state for the server application. In some examples, VSync is be disabled in the server application. Disabling VSync may allow the server application to control timing of frame generation based on client device 204 settings (rather than display settings on the server 202).

The client device 204 may begin execution of the client application (step 250). The client device 204 may initiate a network connection with the server 202 (step 252). The network connection may be via the network 206. The network connection may include a network session that is maintained across multiple interactions (messages/packets) between the client device 204 and the server 202.

The client device 204 may determine a display refresh rate (step 254). The display refresh rate may be the refresh rate of a connected display or another rate the server application on the server 202 should generate and send frames to the client application on the client device 204. The display refresh rate may be a number of frames over a given period (e.g., 60 FPS) or a refresh period (e.g., every 16.67 ms). The client device 204 may send the display refresh rate to the server 202 (at step 256).

The server 202 may receive the display refresh rate (at step 222) and set a render time target based on the display refresh rate (at step 224). The render time target indicates how often the server 202 should render (a render frequency) and send frames to the client device 204. Rendering at the display rate may equalize/synchronize frame generation frequency (on the server 202) with the frames displayed (at the display frame rate of the client device 204). The coordination of the render time target of the server 202 with the display refresh rate of the client device 204 may be useful to reduce latency (due to timing mismatches) and manage the number of frames rendered by the server 202 and sent to the client device 204.

The client device 204 may send state updates to the server 202 (at step 258). State updates may include interactions of the user with the application (e.g., actions in a cloud-gaming environment, keystrokes in a remote desktop environment, etc.). State updates may include any user input (or a lack of user input) including mouse position/clicks, keystrokes; video/audio capture; sensor information; and/or data calculated or compiled based on the foregoing data. Data calculated or compiled based on inputs may be received instruction from a user may be an instruction derived from the input (e.g., to open a folder or application in a remote desktop environment or to move to a particular location or enter a new level in a remote game environment) and may be based on a single or combination of inputs and/or sensor data pre-processed by the client device 204 to determine the instructions.

State updates may also include updates to the display rate, resolution of a frame, or aspect ratio of frames for display. For example, if the client device 204 changed displays (newly connected or previously connected, or across multiple displays), the size of a display window (multiscreen, full screen to partial screen display, partial screen to full screen display), or changed rendering/display settings to change the resolution.

Input may be received continuously (and asynchronously) by the client device 204. Processing of input may be performed by client device at a set schedule (e.g., based on the framerate) or may be performed continuously (e.g., as received). Similarly, state updates may be sent asynchronously (e.g., as received/processed by the client device 204) or at a set frequency (e.g., based on the framerate or a negotiated timing between client device 204 and server 202).

The server 202 may receive the state information (at step 226). In some examples, receiving and/or processing the state information may occur asynchronously and with no particular frequency (e.g., keyboard strokes or mouse clicks of a user of device 204). In other examples, receiving state information may be at a set schedule. The schedule may be based on the frame rate, a preset rate, or a rate negotiated with the client device 204.

The server 202 may process the state information to update the application state on the server 202 (at step 228). Processing the state information may include verifying the state information to determine the validity of the state information/user input. Processing the state information may include updating an application environment within the memory of the server based on the state information. In some examples, processing the state information may include setting an updated render time target and altering the timing of frame generation. Other aspects of frame generation may be updated based on state updates including the resolution/aspect ratio, etc. of generated frames.

As used herein, the application environment refers to one or more data structures that represent the visual elements (in part or whole) of a graphical user interface. The application environment may represent, for example, a 2D or 3D environment. Typically, a GPU may overlay sprites to create a 2D environment. GPUs may also use polygons, and ray tracing to create a 3D environment. For example, a user click performs an action in a game (e.g., picking up an item) that may change the sprites or polygons that correspond to the user's avatar. Updates to the application environment may involve advancing the application environment based on the passage of time, user (and other) inputs, etc. Application environment updates may include, for example, physics/artificial intelligence engines run in a game environment advancing the game based on user input and the passage of time, the state of a document in a word processor may be updated based on user selections and spell check is run on the updated text, etc. The GPU may be used to update the environment. For example, the layout of the user interface may be updated. In another example, data representing pixels may be manipulated. In a further example, sprites, polygons, or tiles that represent objects or background may be updated.

This may be useful, e.g., in a multi-player game environment where the server 202 updates the game state and generates frames for multiple client devices during the same session. Processing the state information may occur at a set frequency (e.g., before rendering the frame or at a regular interval) or as the state updates are received by the server 202. In some examples, the server 202 processes the received state information from the client device 204 along with the state information received from one or more other client devices (or other devices, e.g., other servers) to update the application state.

The server 202 renders one or more frame (at step 230). The server 202 may render a frame at the render time target based on the display refresh rate provided by the client device 204. The server 202 may render frames for a single client device or multiple client devices. In some examples, the same rendered frame is sent to multiple client devices for display.

In some examples, the rendered frames sent to the client device 204 are fully rendered for full screen display on the client device 204. While many of the examples provided herein are in the context of full screen frames being rendered and sent to the client device 204 for display, other examples are contemplated and fully compatible with the present disclosure. For example, in other examples, the frames sent to the client device 204 are for a windowed environment where the frames would be further processed by, e.g., a windowing manager/compositor application on the client device 204 to add additional display elements such as toolbars, menus, overlays, other applications, etc. to the frame prior to display. In other examples, partial frame elements may be generated/rendered on the server 202 and sent to the client device 204. The client application on the client device 204 may composite the received partial frame elements with other rendered portions of the frame to generate a final frame. This final frame may be further combined with further processing to add additional display elements as described above by e.g., a compositor application. In other examples, rather than frames, the server 202 may send state information of the application to the client device 204 for rendering and display. The state information may be specific to a user (e.g., a player's state in a gaming application or a player's state and the state's of other nearby players) or multiple users (e.g., a global state of the gaming application).

Each of these examples pose different timing challenges and deadlines. Where the received frames may be immediately displayed by the client device, the frame receipt timing deadline may be (just prior to) the scanout deadline. Where the received frames are composited by a compositor (or other) application to add additional elements, (just prior to) a presentation deadline that is earlier than the scanout deadline the frame receipt timing deadline. Where the application on the client device 204 composites received and rendered frame elements (or receives only state information), the frame receipt timing deadline may be even earlier than the presentation deadline to ensure that the received frame (or portion of the frame) is displayed at the next available scanout.

The timing of rendering the frame may be set based on the render time target (set during step 224). Based on the render time target, the server 202 may calculate a time to complete rendering the frame. Rendering the frame may be delayed by an offset to synchronize timing with the client device 204. Initially, the offset may be set to 0.

Following rendering of the frame, the server 202 sends the frame to the client device 204 (at step 232). The frame may be sent over the network 206. In an application where the client application and server application are on the same device (e.g., in a P2P application), the server application may send the frame via a bus within the device.

The client device 204 receives the frames sent from the server (at step 260). The client device may process the received frames for display (at step 262) and display the frames (step 264). While frame generation (at the server 202) and display (at the client device 204) would be on the same schedule (equalized), the rendering/sending frames and the display of the frames may not be synchronized. For example, the client device 204 may receive the frames (at step 260) outside of an optimal display timing window, causing the frame display (at step 264) to be delayed by one frame or cause noticeable or excessive studder in the display of frames of the application.

For example, at a display rate of 60 FPS, there is a 16.67 ms display period. For each 16.67 ms display period the server 202 needs to render one frame and the client device 204 needs to display one frame. If that window is missed (by either the server 202 in rendering or on the client device 204 in displaying), the window is missed. When the window is missed one frame may be displayed twice and another frame will not be displayed on the display of the client device 204, causing a studder.

The client device 204 may not be able to immediately display a received frame rendered at the server 202. For example, immediate display of the received frame may not be possible because the frame received is not in a form displayable by the client device or additional information must be added to the frame by the client device 204. The client device 204 processes and presents the frame for display (at step 262). Processing may include rendering a display frame based on the received frame or information from the server 202, compositing a display frame based on the received frame, and placing the processed frame into the display buffer for display at the next scanout. In other examples, the client device 204 is able to immediately display the received frame with no (graphics) processing prior placing the received frame into the display buffer for display at the next scanout.

Following processing, the client device 204 may display the frame (at step 264). In some examples, in order to display the frame, the frame must be received and processed for display within a display period. For example, if a frame is received and at time 16.66 ms, 0.01 ms before the 16.67 ms the next vertical blanking interval (vblank) deadline, the received frame might not be processed and placed into the frame buffer for the frame to the display by the vblank/VSync deadline and was thus received outside the display period. The frame may be lost to studder or the display of the frame delayed.

The client device 204 may capture a completion time, the time processing and/or presenting the frame has completed, for later use in determining whether to send a pacing message and/or an amount of offset. In some examples, the client device 204 may capture the time of the next vblank for use in calculating the timing offset. In other examples, the client device 204 may calculate the time of the next vblank based on the framerate. The difference between the time of the next vblank and the completion time may be calculated. This difference may be used to determine whether or not to offset the rendering time of the frame on the server 202, such that the timing of the next frame sent by the server side is optimal for the reduction of latency.

In some examples, processing delay may be approximately 25% of the frame display time. In other exemplary environments, processing delay may be closer to 50% of the frame display time. This means if a received frame is going to be displayed in the next frame window without studder, the frame may be submitted for processing (via e.g., a presentKHR command) earlier than a scanout time to account for this additional processing delay. In exemplary environments, the optimal time to receive the frame is at time 12.5025 ms (that is, 75%) of the 16.67 ms frame window where processing delays are 25% and at time 8.335 ms (that is, 50%) of the 16.67 ms frame window in the 50% example.

In many computing environments, the timing between devices is not synchronized. Other effects outside the control of the client device 204 and server 202 may also impact timing between devices such as network delays. For example, an application on the server 202 generates and sends frames and an application on the client device 204 receives them. The timing of the frame generation on the server side is not the same time as on the client side due to various forms of latency. Some of these forms of latency include server delay: the delay to process state information on the server 202, to render the frames on the server 202, to send the frames to client device 204 by the server 202; delay over the network 206 including: propagation delay over the media, processing delay by devices, etc.; and delay at the client device 204 to receive, process, and display the frames. The effect of the lack of synchronization and delay is the server 202 may render frames that arrive at the client device 204 at a suboptimal time (e.g., outside a timing window prior to an optimal display time).

The client device 204 may know or may calculate an optimal time for the frame to arrive (from the server 202). In some examples, this optimal time is just prior to the next scan out time. In some examples, the optimal time is just prior to a client-side processing delay period (for the client device 204 to process the incoming frames and prepare them for display) before the next scanout time (also known as the vblank or VSync deadline).

The client device 204 may determine whether to send a pacing message to the server 202 (at step 266). In one example, the client device 204 may determine to send a pacing message when display of the frame missed the vblank or VSync deadline (and was either not displayed or the display was delayed). In another example, the determination about whether to send a pacing message is based on a comparison between the time the current frame is queued/presented for display and/or rendered, depending on the GPU driver (CFrameRendered) and an optimal timing deadline (OptimalTimingDeadline). For example,
if CFrameRendered>OptimalTimingDeadline, send a pacing message signal to start rendering earlier (e.g., 1 ms earlier);
if CFrameRendered<=OptimalTimingDeadline and D>TV, send a pacing message signal to start rendering later (e.g., 1 ms later); and
if CFrameRendered<=OptimalTimingDeadline and D<=TV, do not send a pacing message.
where:
PresentationDeadline is the processing or presentation deadline that a frame can be presented at the client device 204 and be considered for the next display scanout or may be substituted with the vblank/VSync time of the frame;
TV is a jitter window, TV may be calculated as: 1000/(display_frame_rate))/5;

$$OptimalTimingDeadline = PresentatonDeadline - TV ; and$$

$$D = OptimalTimingDeadline - CFrameRendered .$$

In one example, PresentationDeadline is determined using, e.g., using a GPU API extension, such as a Vulkan extension. For example, the PresentationDeadline may be determined using a GPU API extension such as in Vulkan with the “VK_EXT_present_timing Extension,” described in and available at https://github.com/KhronosGroup/Vulkan-Docs/pull/1364 or the proposed extension “Present-timing: Enhanced Presentation Timing Requests and Events” extension described in and available at https://gitlab.freedesktop.org/wayland/wayland-protocols/-/merge_requests/45, the foregoing incorporated by reference in their entireties. In another example, PresentationDeadline is estimated based on estimating a processing delay (e.g., 25% or 50% of the frame time) and calculating the PresentationDeadline based on the difference of the processing delay from the vblank/VSync time. In other examples, PresentationDeadline may be estimated based on estimating a processing delay from previous frames and finding the difference between a of the processing delay from the vblank/VSync time. In further examples, PresentationDeadline may be estimated based on a latest recorded time a frame was presented and was displayed as the next frame. Alternatively, the PresentationDeadline may be substituted with the vblank/VSync time of the frame.

While some examples use a fixed 1 ms is as an offset in a pacing message, different offsets may be used based on different criteria. For example, without limitation, an average may be taken from the last 5 frames sent and the average may be used to set an offset greater or less than 1 ms. Additionally, nanoseconds may be used instead of milliseconds such that a more precise offset may be generated.

Other methods to determine whether to send a pacing message may be used in combination with or separate from the aforementioned approach such as, without limitation weighted moving averages, stochastics, etc. For example, a moving average of the CFrameRendered value last number (e.g., 5, 10, etc.) frames may be compared with the OptimalTimingDeadline of the last number of frame. The delta/difference (D) value may be determined for the frames and then if the average difference, D, of the frames is less than the jitter window (TV) a pacing message may be sent. Additionally, the jitter window may be independent of the frame rate (e.g., a fixed 1 ms, 2 ms, 8 ms) or may vary depending on other factors (e.g., network timing conditions).

To remedy receiving frames at a suboptimal time, the client device 204 sends a pacing message to the server 202 (at step 268). The pacing message instructs the server 202 to offset (e.g., delay, speed up) the next time the server 202 renders a frame so when the frame travels thru the render pipeline and over the transmission medium (network/Internet, memory) into the client device 204, it arrives slightly sooner or later. In some examples, the pacing message may indicate offsetting rendering by a certain fixed period of time. In one example, the pacing message may indicate a specific amount of time (in, e.g., milliseconds or nanoseconds) to offset rendering. In other examples, the pacing message may indicate a direction to offset rendering and the server 202 may offset a fixed period of time (earlier or later) based on the message. As used in the example above, the fixed period of time may be 1 ms. The specific period of time and/or the fixed period of time may be limited (capped) to limit large swings in the rendering time between frames.

The server 202 receives and processes the pacing message (at step 234). In some examples, the server 202 may set an offset to modify the timing of beginning to render the next frame (e.g., a rendering start time) based on the pacing message (at step 236). Skewing the start time for rendering the frame allows the client device 204 and the server 202 to synchronize frame generation timing. Such synchronization allows frames generated/rendered on the server 202 to be received by the client during an optimal time window for further processing, presentation, and display. This may minimize latency experienced due to a timing mismatch (where, e.g., frames are received at or presented by the client device 204 too late for display during the next scanout period).

Rendering timing (and frequency) may be specific to a session/client device 204. Where multiple client devices have sessions with the server 202 (and the server application or multiple instances of the server application), the server 202 may be configured to render frames at a frequency and timing specific to each client device. The rendering may be based on the frequency data (based on, e.g., the display refresh rate of the client device 204 or the render time target) or synchronization data (e.g., pacing message(s)/timing offset data received by the server 202).

Limiter code may used to control the timing of frame rendering on the server 202. In some examples, the limiter code is compiled into the server application running on the server, included within a graphics API, display server, kernel, or GPU driver of the server 202. In some examples, the limiter code may be a shim that intercepts and modifies data between the application and the kernel, graphics API, and/or GPU driver. In some examples, the shim is a shared object library that gets loaded into the server application at runtime (e.g., .dll, .so, etc.). In other examples, limiter code/shim is compiled into the server application. In further examples, the limiter code/shim is in the GPU driver allowing the limiter to operate on the hardware directly. In additional examples, the limiter code/shim is in the Operating System (OS)/kernel. The limiter code/shim may also be a part of or an extension to a graphics API such as Vulkan, DirectX, OpenGL, etc. Other implementations consistent with aspects of the present disclosure of the limiter code, how the limiter code is executed, and at which layer of the GUI application stack executes the limiter code on the server 202 will be apparent to those of ordinary skill in the art when provided the present disclosure. Such implementations may depend on the environment/architecture of the server 202.

One exemplary implementation of the limiter code is as a shared object shim associated with the server application (on server 202) as shown in Code Segment 1. CLIENT_REFRESH_RATE is set to be the refresh rate of the client and LIMITER_TIME_OFFSET is set as the offset to skew the timing of the next frame based on the offset/pacing message sent by the client device 204. In this implementation VSync may be disabled at the server to allow the server application to set its own render timing (based on the client device 204).

Code Segment 1

| | |
|---|---|
| 01: | void limiter (int fps) { |
| 02: | static int64_t nextFrame = 0; |
| 03: | int64_t targetFrameTime = 100000000000011 / fps; |
| 04: | int64_t now = current_nanoseconds ( ); |
| 05: | if (nextFrame == 0) { |
| 06: | nextFrame = now; |
| 07: | } |
| 08: | int64_t sleepTime = nextFrame − now; |
| 09: | nextFrame += targetFrameTime; |
| 10: | nextFrame += LIMITER_TIME_OFFSET; |
| 11: | LIMITER_TIME_OFFSET = 0; |
| 12 : | if (sleepTime > 0) { |
| 13: | do_nanosleep ( sleepTime ); |
| 14: | } |
| 15: | } |

In Code Segment 1, the functionality of VSync (controlling the timing and limiting the rendering of frames) is simulated via sleeping (using the do_nanosleep function). Since VSync is disabled, the server application is able to render frames at the same rate as the display of the client device 204. In implementations with multiple applications (or sessions with multiple clients) running on a server 202, the rate of frame rendering and the timing of rendering may vary between each application and session. The rendering timing may be gradually shifted based on receiving a pacing message with an instruction to apply a LIMITER_TIME_OFFSET.

In an exemplary implementation using the render loop of an X11 OpenGL application (GLX) a call to the limiter code (of e.g., Code Segment 1) may be called, via the shim, and inserted after a call to glXSwapBuffers as shown in Code Segment 2.

Code Segment 2

| | |
|---|---|
| 01: | EXPORT |
| 02: | void glXSwapBuffers( void* dpy, void* drawable ) { |
| 03: | realglXSwapBuffers( dpy, drawable ); |
| 04: | limiter( CLIENT_REFRESH_RATE ); |
| 05: | } |

In other implementations, in place of a using shared object shims, the server application of the server 202 may use embedded code, the GPU driver may track applications running on a system using unique process identifiers (PIDs), or the kernel may track applications running on the server 202 using unique PIDs.

The server 202 may render the next frame for display at the client device 204 (at step 238). The next frame may be based on an updated application state. The updated application state may incorporate user input and other state information received from the client device 204 (as described with respect to steps 258 and 226-228). In some examples, the pacing messages alters/shifts the timing of updating the application state by the server 202. Rendering the next frame may be limited by a timing set based on the frame rate of the client device and pacing messages sent by the client device 204. Thus, a start time for rendering the next frame may be shifted earlier (an earlier start time) or later (a later start time) based on an instruction in the pacing message. For example, the server 202 may delay rendering the next frame by a delay period or reduce or cut short an idle period between rendering frames to render the next frame earlier than scheduled (based on the rendering frame rate).

The server 202 may send the rendered next frame to the client device 204 (at step 240). The client device 204 may receive the next frame (at step 270). The frame may be processed and displayed, and a determination made as to whether to send a pacing message may be made in response to receiving the next frame (similar to the steps 262-266).

The client device 204 may send successive pacing messages (similar to step 268) to the server 202 until the client device 204 receives the frames the server 202 generates within a timing window prior to the optimal display timing, of the client device 204. Successive pacing messages may be sent, after subsequent frames are received, as long as the display timing at the client device 204 is falls outside of an optimal window such that frames are received, processed, and presented for display shortly before (e.g., within a jitter window of) a presentation deadline.

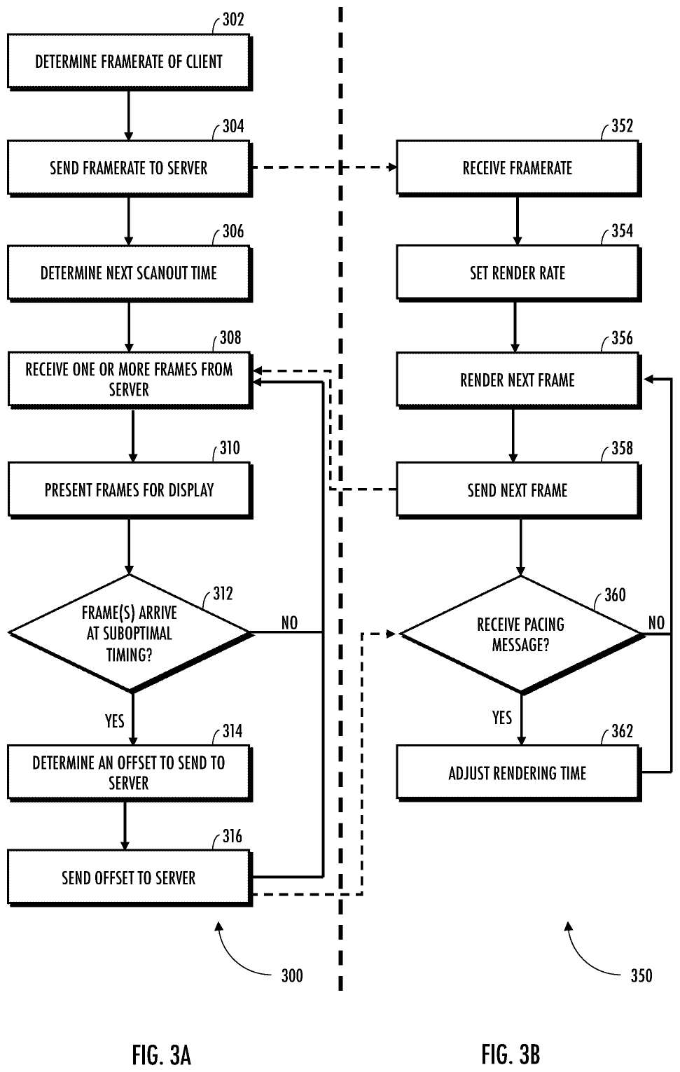

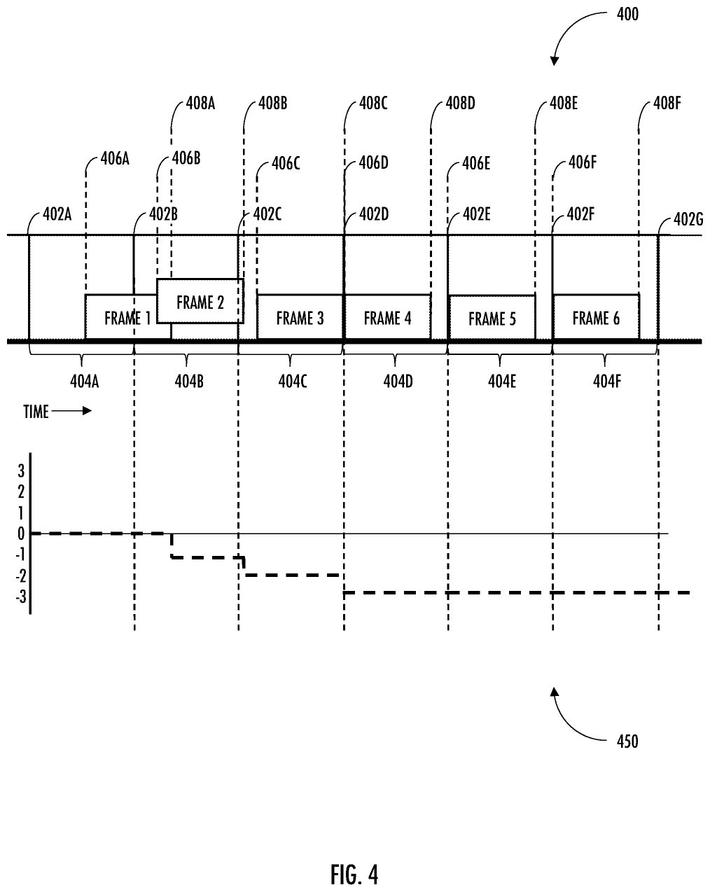

FIG. 3A illustrates a flow diagram of an exemplary client application according to aspects of the present disclosure. The steps of method 300 may be performed by a client device (e.g., client device 204) in communication with a server (e.g., server 202) for generation of frames for display.

A client device may run an application based on, e.g., user input. The application initializes a connection with a remote application on a server. At step 302, the client device determines the frame rate of a display (e.g., in hertz) of the client device. One exemplary display frame rate/frequency is 59.97 Hz which is commonly referred to 60 FPS). Other exemplary frame rates are approximately 60 Hz, 90 Hz, 120 Hz, etc.

At step 304, the client device may send the determined frame rate to the server. While typically sending the frame rate to the server would occur during the beginning/initialization of a session between a client device and a server, the client device may determine that a change in the frame rate has occurred which would prompt the client device to send the new frame rate to the server. In response, the server may render frames at the determined rate, the display rate of the client device. As a result, the display/rendering frequency of the display of the client device is the same (or is in lockstep with) the rendering frequency of the server. The server, in a multi-client environment, may render frames at a different frequency (and/or with different timing) for different client devices.

At step 306, the client device may determine the next scanout time for displaying a frame. In some examples, this may be done via a Vulkan extension that determines the next scanout time. In other examples, via OpenGL, the next scanout time may be determined by running a shadow window that has VSync activated and sending a message to the main window when the scanout is signaled.

At step 308, the client device may receive a frame from the server. In some examples, the client device may receive multiple frames from the server. In some examples, the frame is a full screen frame. In other examples, it is a frame of a window smaller than the full screen or a portion of a window.

At step 310, the client device may present the frame for display. The client device may store the time the frame was presented for display. In some examples, the received frame may be re-rendered by the client device or the client device may otherwise further process the frame prior to presentation. The client device may store the time the frame completed re-rendering/processing.

At step 312, the client device may determine whether the frame arrived during a nonoptimal time or nonoptimal time window. The determination may be based on whether the frame was displayed during a calculated optimal time window (see calculation of the OptimalTimingDeadline and D above), whether the frame was received by the client device and presented for display by the client application of the client device prior to a presentation deadline (for display after the next vblank/in the succeeding frame display period), and/or whether the frame was displayed by the client device during the frame display period succeeding the frame display period the frame was received by the client device.

In some examples, rather than determining whether a single frame arrived at a nonoptimal time, the client device may make a determine whether a percentage (e.g., 80%) of the last number of frames (e.g., 5 frames, 10 frames, etc.) arrived an optimal time. If the frame, from the server, arrives at an optimal time (step 312, “no” branch), the client application on the client device may elect not to send a pacing message to the server. The client device may wait for the next frame(s) from the server (returning to step 308).

If the frame, from the server, arrives at a nonoptimal time window (step 312, “yes” branch), the client device may elect to send a pacing message to the server to offset the time future frames are rendered and/or sent to the client device. The time offset may not slowdown or speedup the frequency of rendering frames on the server. Instead, the time offset shifts the timing of rendering/sending at the server, so the frame arrives earlier or later to better align with an optimal time window at the client device.

At step 314, an offset for a pacing message is determined. In some examples, the offset may be a (binary) value indicating whether rendering/sending the next frame should be accelerated (shifted earlier) or delayed (shifted later). In other examples, an offset may be calculated as, or based on, the difference, D, between CFrameRendered and the OptimalTimingDeadline.

At step 316, the offset is sent to the server. The offset may be sent as a payload of a pacing message. In other examples, the offset may be sent as part of a different message type (with e.g., status updates) with other information or in a dedicated message. The client device may wait for the next frame(s) from the server (returning to step 308).

FIG. 3B illustrates a flow diagram of an exemplary server application according to aspects of the present disclosure. The steps of method 350 may be performed by a server (e.g., server 202) in communication with a client device (e.g., client device 204) for generation of frames for display.

Upon initialization, the client device sends the determined frame rate to the server (at step 304). At step 352, the server may receive the frame rate from the client device. At step 354, the server may set a render rate (or render target) to synchronize frame rendering with the client device. At step 356, the server may render a frame at the render rate. At step 358, the server may send the frame to the client device (which the client device may receive at step 308). The server may be configured to periodically render frame images to be sent over a communication interface to the client device for further rendering by the client device into its frame buffer intended for output to a client display device.

A pacing message may be sent by the client device to the server (at step 316). The pacing message may indicate an offset to skew its clock so that future frames arrive at the client device earlier or later. In some examples the offset may indicate a certain amount of time (milliseconds, microseconds, nanoseconds, etc.). In other examples, the offset may indicate which direction (earlier or later) to skew the rendering time and the server may adjust the rendering timing by a set amount. If the server receives a pacing message from the client device (at step 360, “yes” branch), the server may adjust the rendering time of the next frame (at step 362). Adjusting the rendering time may include altering an idle period between generating frames (based on the pacing message). The server may then proceed to render the next frame (at step 356) based on the updated rendering timing. If the server does not receive a pacing message from the client device (at step 360, “no” branch), the server may proceed to render the next frame (at step 356).

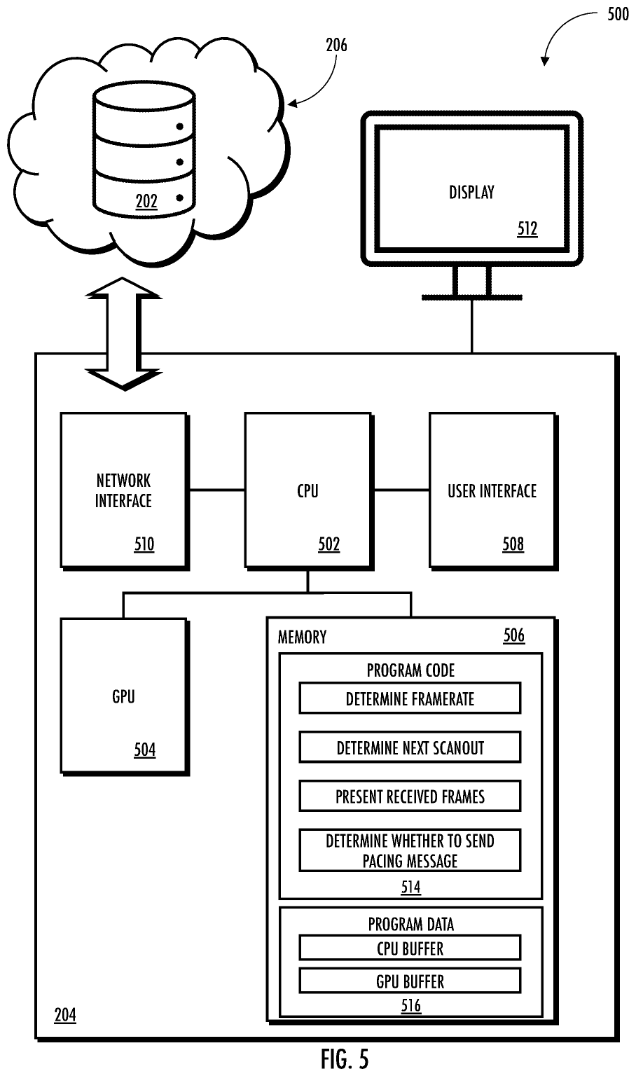

FIG. 4 illustrates an exemplary timing diagram 400 of frames received and displayed by an exemplary client device and an exemplary timing graph 450 of a timing offset/clock skew on an exemplary server. The timing diagram 400 and timing graph 450 illustrate an example cumulative clock offset/skew on the server and how receipt of frames at the client device is used to offset/skew future frame rendering on the server. Frame rendering on the server may be based on a timing deadline 402A, 402B, 402C, 402D, 402E, 402F, and 402G of a frame at the client device.

The timing deadlines 402A-G may be deadlines for a frame to arrive at the client device such that the client device can process the frame for display and the frame may be displayed at the next opportunity (e.g., the next frame/scanout). In some examples, where the processing time is minimal (e.g., where the received frame is needs little or no processing by the application or a compositor), the timing deadlines 402A-G are display scanout boundaries. In other examples, the timing deadlines 402A-G are presentation deadlines, which are earlier deadlines than the display scanout boundaries. As used herein, the presentation deadline is a deadline by which a frame must be received by the client device in order to allow the client device to process and present the frame for display at the next scanout. The presentation deadline may be determined based on a GPU API call or estimated based on previous data (as described in more detail above).

In some examples, the timing deadlines 402A-G are display scanout boundaries. The display scanout boundaries are time periods when the display has completed scanout of the current frame. At a display scanout boundary, the display buffer flips to another buffer to display the next frame. A vertical blank (vblank) interval is the time interval between scanning out the last line of the current frame and the first line of the next frame. The vblank indicates the completion of the frame currently displayed and the beginning of scanout for the next frame. If VSync is enabled, after frame presentation the application is prevented/blocked from processing (and presenting) the next frame. Instead, the application will be blocked or will idle. At the vblank, a notification (e.g., an interrupt) is sent to the application that unblocks or allows the application to continue and process a new frame.

The windows of time between the timing deadlines 402A-G is the frame length. Where the timing deadlines 402A-G are the display scanout boundaries, the windows of time are the display period 404A, 404B, 404C, 404D, 404E, and 404F of a frame.

In some examples, display scanout occurs at a regular interval or substantially regular interval (due to, e.g., random timing jitter). In one example, the client device has a display that refreshes at 60 frames per second (FPS), there is a 16.67 ms delay between frames (i.e., a display period 404A-F of 16.67 ms). In a display with a refresh rate of 90 FPS, there is an 11.11 ms delay between frames. In a display with a refresh rate of 120 FPS, there is an 8.33 ms delay between frames. The delay between frames may be calculated as 1/frame rate. In other examples, the display scanout occurs at variable period of time (as the scanout operation by the display/video card does not necessarily take the exact same amount of time due to hardware timing drift, a variable frame rate display, etc.).

In some embodiments, display timing at the client device is controlled by VSync (e.g., a VSync setting is enabled). The display scanout boundaries may also be the VSync deadline. The VSync deadline is the deadline for a frame to be placed in an inactive (i.e., not displaying) frame buffer before the buffer “flips” to an active state and begins scanout of the frame.

The right edge of a frame is the server render start time. The left edge of a frame is the time the frame arrives at the client device for further processing and presentation. Accordingly, frame 1 begins rendering on the server at time 406A and arrives at the client device at time 408A; frame 2 begins rendering on the server at time 406B and arrives at the client device at time 408B; frame 3 begins rendering on the server at time 406C and arrives at the client device at time 408C; frame 4 begins rendering on the server at time 406D and arrives at the client device at time 408D; frame 5 begins rendering on the server at time 406E and arrives at the client device at time 408D; and frame 6 begins rendering on the server at time 406F and arrives at the client device at time 408F. The length of the frame (from time 406A-F to 408A-F) represents the time a frame takes to render on the server and be received by the client device including transit time (over a network, where applicable). Where the length of a frame (e.g., frame 1 and frame 2) is shown crossing a timing deadline, this indicates the frame arrives at a nonoptimal time. In response, the client device may signal (via a pacing message) to the server to start to render the next frame earlier or later. Even where a frame does not cross a timing deadline (e.g., frame 3), a pacing message may be sent to move frame rendering closer to an optimal window. That optimal window may be some period of time before the timing deadline 402A-G. That period of time may be a jitter window (TV, as defined above).

At the time of timing deadline 402A, a server application running on a server and a client application running on a client device initialize and connect (e.g., via a network connection). The client application sends a frame rate to the server which begins to render frames to send to the client device for display at the received rate. The cumulative time offset at the server is currently 0 ms (as shown in timing graph 450).

During the display period 404A, frame 1 is rendered by the server at time 406A and sent to the client device where frame 1 is received at time 408A (in display period 404B). Visually, frame 1 is shown as being received at a nonoptimal time as frame 1 crosses the timing deadline 402B. In some examples, the display of frame 1 is delayed one frame by the client device because it was not received before the timing deadline 402B. The client device sends a pacing message to the server to render the frame earlier. The server offsets the render time by 1 ms earlier; setting the cumulative time offset to −1 ms during display period 404B.

In some examples, the offset time used by the server is not a cumulative value (as illustrated in the timing graph 450). Instead, in other examples, the start time of rendering the next frame is offset by the server after receiving a pacing message (see Code Segment 1, above) and the offset is reset to 0 but the timing of rendering subsequent frames is impacted by the render time of the current frame offset by a frame duration. In such an example, the timing offset does not need to be stored persistently by the server.

During the display period 404B, frame 2 is rendered by the server at time 406B and sent to the client device where frame 2 is received at time 408B (in display period 404C). Visually, frame 2 is shown as being received at a nonoptimal time as frame 1 crosses the timing deadline 402C. In some examples, the display of frame 2 is delayed one frame by the client device. In other examples, frame 2 is never displayed as it is overridden in the frame buffer by, e.g., frame 3, prior to display on the client device. The client device sends a pacing message to the server to render the frame earlier. The server offsets the render time by 1 ms earlier; setting the cumulative time offset to −2 ms during display period 404C.

During the display period 404C, frame 3 is rendered by the server at time 406C and sent to the client device where frame 3 is received at time 408C just prior to the timing deadline 402D. Visually, frame 3 is not shown as crossing the timing deadline 402D. But frame 3 was received at a nonoptimal time as frame 3 was not received prior to a jitter window (TV, as defined above) prior to the timing deadline 402D. The client device sends a pacing message to the server to render the frame earlier. A pacing message is sent despite the frame being received by the timing deadline as it was not received prior to the jitter window and subsequent frames could easily be received after the timing deadline 402D. The server offsets the render time by 1 ms earlier; setting the cumulative time offset to −3 ms in display period 404D.

During the display period 404D, frame 4 is rendered by the server at time 406D and sent to the client device where frame 4 is received at time 408D prior to the timing deadline 402E. As such, frame 4 is received at an optimal time as frame 4 is received prior to a jitter window prior to the timing deadline 402E. The client device does not send a pacing message to the server. The cumulative time offset remains at −3 ms in display period 404E as no pacing message was sent to change the rendering offset time.

During the display period 404E, frame 5 is rendered by the server at time 406E and sent to the client device where frame 5 is received at time 408E prior to the timing deadline 402F. As such, frame 5 is received at an optimal time as frame 5 is received prior to a jitter window prior to the timing deadline 402F. The client device does not send a pacing message to the server. The cumulative time offset remains at −3 ms in display period 404F as no pacing message was sent to change the rendering offset time.

During the display period 404F, frame 6 is rendered by the server at time 406F and sent to the client device where frame 6 is received at time 408F prior to the timing deadline 402G. As such, frame 6 is received at an optimal time as frame 6 is received prior to a jitter window prior to the timing deadline 402G. The client device does not send a pacing message to the server. The cumulative time offset remains at −3 ms as no pacing message was sent to change the rendering offset time.

Timing graph 450 illustrates a gradual change in offset over time to compensate for optimal timing deadlines. As illustrated, a 1 ms offset may be applied after each of frames 1, 2, and 3. Once the timing of the frames sent has been optimized, no further adjustment of the offset may be needed, and the cumulative offset may remain at −3 ms until further adjustment is indicated.

### Exemplary Client Device

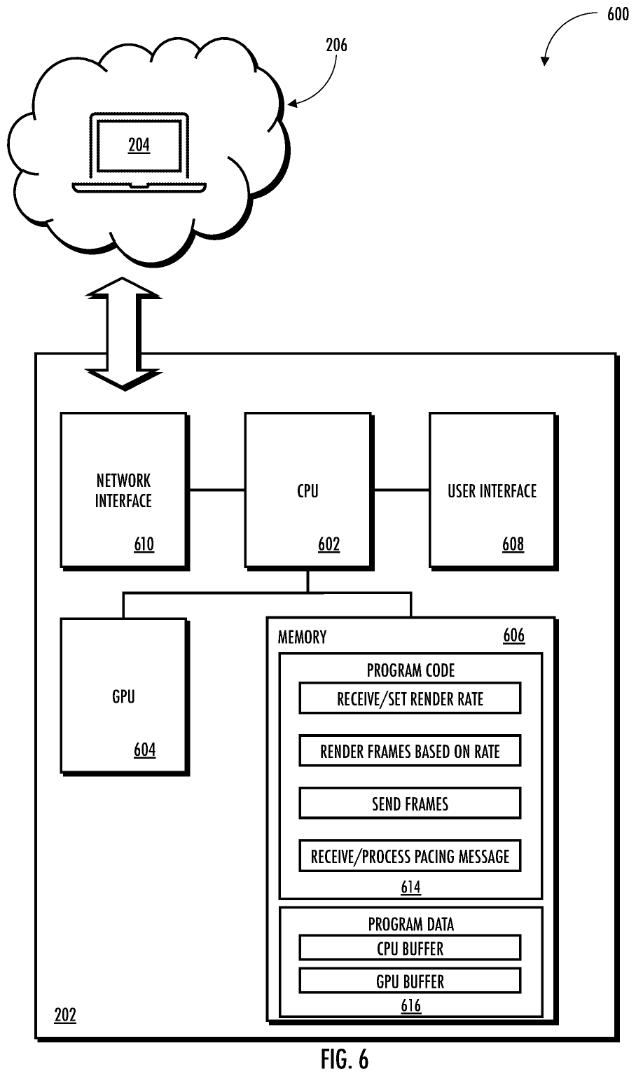

FIG. 5 is a logical block diagram 500 of client device 204, useful in conjunction with various aspects of the present disclosure. The client device 204 includes a processor subsystem (including a central processing unit (CPU 502)) and a graphics processing unit (GPU 504)), a memory subsystem 506, a user interface subsystem 508, a network/data interface subsystem 510, and a bus to connect them. The client device 204 may output to display 512. The client device 204 may be connected and send data to/receive data from a server 202 via a network 206. During operation, a client application running on the client device 204, sends messages to the server 202 to synchronize the rate and timing of frame rendering (though sending frame rate and pacing messages) and submission on the server 202 to receive frames at an optimal time for display to reduce latency at the client device 204. In one exemplary embodiment, the client device 204 may be a computer system that can receive and display frames. Still other embodiments of source devices may include without limitation: a smart phone, a wearable computer device, a tablet, a laptop, a workstation, a server, and/or any other computing device (including, e.g., server 202).

In one embodiment, the processor subsystem may read instructions from the memory subsystem and execute them within one or more processors. The illustrated processor subsystem includes a graphics processing unit (GPU 504) (or graphics processor) and a central processing unit (CPU 502). In one specific implementation, the GPU 504 performs rendering and display of image data; GPU tasks may be parallelized and/or constrained by real-time budgets. GPU operations may include, without limitation: graphics pipeline operations including input assembler operations, vertex shader operations, tessellation operations, geometry shader operations, rasterization operations, fragment shader operations, and color blending operations. Operations may be fixed-function operations or programmable (by e.g., applications operable on the CPU 502). Non-pipeline operations may also be processed (e.g., compute shader operations) by the GPU 504. In one specific implementation, the CPU 502 controls device operation and/or performs tasks of arbitrary complexity/best-effort. CPU operations may include, without limitation: operating system (OS) functionality (power management, UX), memory management, etc. Other processor subsystem implementations may multiply, combine, further subdivide, augment, and/or subsume the foregoing functionalities within these or other processing elements. For example, multiple GPUs may be used to perform high complexity image operations in parallel.

In one embodiment, the user interface subsystem 508 may be used to present media to, and/or receive input from, a human user. In some embodiments, media may include audible, visual, and/or haptic content. Examples include images, videos, sounds, and/or vibration. In some embodiments, input may be interpreted from touchscreen gestures, button presses, device motion, and/or commands (verbally spoken). The user interface subsystem 508 may include physical components (e.g., buttons, keyboards, switches, joysticks, scroll wheels, etc.) or virtualized components (via a touchscreen). In one exemplary embodiment, the user interface subsystem 508 may include an assortment of a touchscreen, physical buttons, a camera, and a microphone.

In one embodiment, the network/data interface subsystem 510 may be used to receive data from, and/or transmit data to, other devices (e.g., server 202). In some embodiments, data may be received/transmitted as transitory signals (e.g., electrical signaling over a transmission medium). In other embodiments, data may be received/transmitted as non-transitory symbols (e.g., bits read from non-transitory computer-readable media). The network/data interface subsystem may include: wired interfaces, wireless interfaces, and/or removable memory media. In one exemplary embodiment, the network/data interface subsystem 510 may include network interfaces including, but not limited to: Wi-Fi, Bluetooth, Global Positioning System (GPS), USB, and/or Ethernet network interfaces. Additionally, the network/data interface subsystem 510 may include removable media interfaces such as: SD cards (and their derivatives) and/or any other optical/electrical/magnetic media (e.g., MMC cards, CDs, DVDs, tape, etc.)

The memory subsystem may be used to store (write) data locally at the client device 204. In one exemplary embodiment, data may be stored as non-transitory symbols (e.g., bits read from non-transitory computer-readable mediums.) In one specific implementation, the memory subsystem 506 is physically realized as one or more physical memory chips (e.g., NAND/NOR flash) that are logically separated into memory data structures. The memory subsystem may be bifurcated into program code 514 and/or program data 516. In some variants, program code and/or program data may be further organized for dedicated and/or collaborative use. For example, the GPU 504 and CPU 502 may share a common memory buffer to facilitate large transfers of data therebetween. In other examples, GPU 504 and CPU 502 have separate or onboard memory. Onboard memory may provide more rapid and dedicated memory access.

Additionally, memory subsystem 506 may include program data 516 with a CPU Buffer and a GPU buffer. GPU buffers may include display buffers configured for storage of frames for rendering, manipulation, and display of frames.

In one embodiment, the program code includes non-transitory instructions that when executed by the processor subsystem cause the processor subsystem to perform tasks which may include: calculations, and/or actuation of the sensor subsystem, user interface subsystem, and/or network/data interface subsystem. In some embodiments, the program code may be statically stored within the client device 204 as firmware. In other embodiments, the program code may be dynamically stored (and changeable) via software updates. In some such variants, software may be subsequently updated by external parties and/or the user, based on various access permissions and procedures.

In one embodiment, the tasks are configured to: determine framerate of the display 512, send the framerate to the server 202 (via the network/data interface subsystem 510); determine a next scanout time; receive one or more frames from server 202 (via the network/data interface subsystem 510); process and present frames for display on display 512 (via the GPU 504); determine whether the received frames arrived at a nonoptimal time; determine a timing offset to send to the server 202; and send the timing offset to the server 202 (via the network/data interface subsystem 510).

The client device 204 may be connected to a display 512. The display 512 may be integrated into client device 204 via the bus and GPU 504 or may be connected to client device 204 via an external display connector (e.g., HDMI, USB-C, VGA, Thunderbolt, DVI, DisplayPort, etc.). Frames are individual images of a sequence of images that are shown on the display 512. For example, a sequence of video images may be played at 24 frames per second (or 24 Hz) to create the appearance of motion and/or a game may be rendered and displayed at 60 frames per second (or 60 Hz). A refresh rate may reflect how often the display 512 updates frames being shown. The display 512 may include any suitable configuration for displaying one or more frames rendered by the client device 204. For example, the display 512 may include a liquid crystal display (LCD), touchscreen LCD (e.g., capacitive display), light emitting diode (LED) display, projector, or other display device to present information to a user of the client device 204 in a visual display.

### Exemplary Server

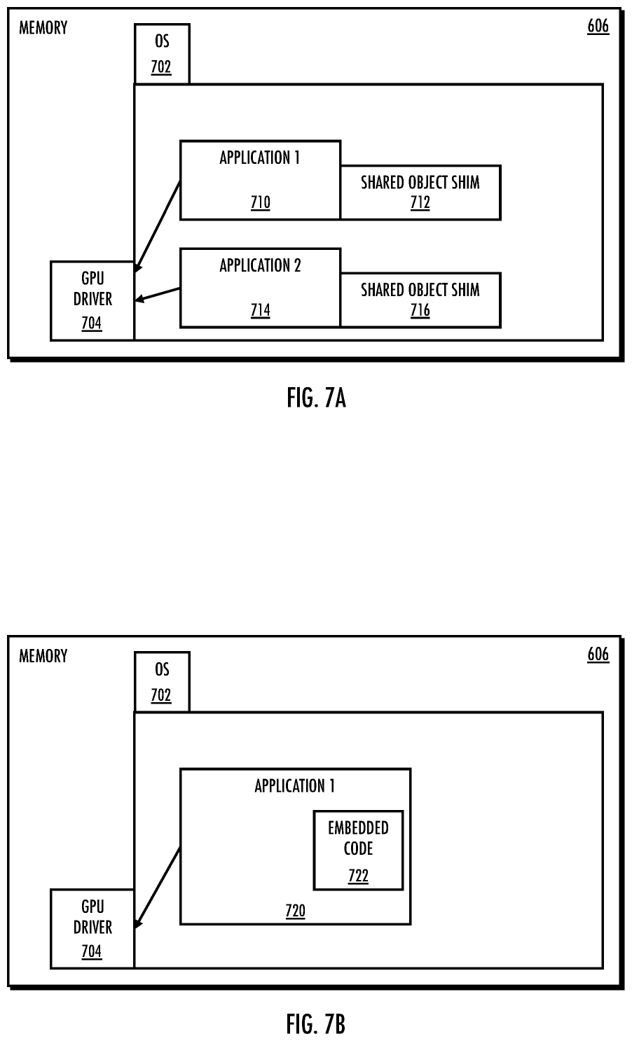

FIG. 6 is a logical block diagram 600 of server 202, useful in conjunction with various aspects of the present disclosure. The server 202 includes a processor subsystem (including a central processing unit (CPU 602)) and a graphics processing unit (GPU 604)), a memory subsystem 606, a user interface subsystem 608, a network/data interface subsystem 610, and a bus to connect them. The server 202 may output to display 612. The server 202 may be connected and send data to/receive data from the client device 204 via a network 206. During operation, a server application running on the server 202, synchronizes the rate and timing of frame rendering (though receiving and processing frame rate and pacing messages) and sending frames to the client device 204 to enable the client device 204 to receive frames at an optimal time for display. In one exemplary embodiment, the server 202 may be a computer system that can process frames for display. Still other embodiments of source devices may include without limitation: a smart phone, a wearable computer device, a tablet, a laptop, a workstation, a server, and/or any other computing device (including, e.g., client device 204).

In one embodiment, the processor subsystem may read instructions from the memory subsystem and execute them within one or more processors. The illustrated processor subsystem includes a graphics processing unit (GPU 604) (or graphics processor) and a central processing unit (CPU 602). In one specific implementation, the GPU 604 performs rendering and display of image data; GPU tasks may be parallelized and/or constrained by real-time budgets. GPU operations may include, without limitation: graphics pipeline operations including input assembler operations, vertex shader operations, tessellation operations, geometry shader operations, rasterization operations, fragment shader operations, and color blending operations. Operations may be fixed-function operations or programmable (by e.g., applications operable on the CPU 602). Non-pipeline operations may also be processed (e.g., compute shader operations) by the GPU 604. In one specific implementation, the CPU 602 controls device operation and/or performs tasks of arbitrary complexity/best-effort. CPU operations may include, without limitation: operating system (OS) functionality (power management, UX), memory management, etc. Other processor subsystem implementations may multiply, combine, further subdivide, augment, and/or subsume the foregoing functionalities within these or other processing elements. For example, multiple GPUs may be used to perform high complexity image operations in parallel.

In one embodiment, the user interface subsystem 608 may be used to present media to, and/or receive input from, a human user. In some embodiments, media may include audible, visual, and/or haptic content. Examples include images, videos, sounds, and/or vibration. In some embodiments, input may be interpreted from touchscreen gestures, button presses, device motion, and/or commands (verbally spoken). The user interface subsystem 608 may include physical components (e.g., buttons, keyboards, switches, joysticks, scroll wheels, etc.) or virtualized components (via a touchscreen). In one exemplary embodiment, the user interface subsystem 608 may include an assortment of a touchscreen, physical buttons, a camera, and a microphone.

In one embodiment, the network/data interface subsystem 610 may be used to receive data from, and/or transmit data to, other devices (e.g., client device 204). In some embodiments, data may be received/transmitted as transitory signals (e.g., electrical signaling over a transmission medium). In other embodiments, data may be received/transmitted as non-transitory symbols (e.g., bits read from non-transitory computer-readable media). The network/data interface subsystem may include: wired interfaces, wireless interfaces, and/or removable memory media. In one exemplary embodiment, the network/data interface subsystem 610 may include network interfaces including, but not limited to: Wi-Fi, Bluetooth, Global Positioning System (GPS), USB, and/or Ethernet network interfaces. Additionally, the network/data interface subsystem 610 may include removable media interfaces such as: SD cards (and their derivatives) and/or any other optical/electrical/magnetic media (e.g., MMC cards, CDs, DVDs, tape, etc.)

The memory subsystem may be used to store (write) data locally at the server 202. In one exemplary embodiment, data may be stored as non-transitory symbols (e.g., bits read from non-transitory computer-readable mediums.) In one specific implementation, the memory subsystem 606 is physically realized as one or more physical memory chips (e.g., NAND/NOR flash) that are logically separated into memory data structures. The memory subsystem may be bifurcated into program code 614 and/or program data 616. In some variants, program code and/or program data may be further organized for dedicated and/or collaborative use. For example, the GPU 604 and CPU 602 may share a common memory buffer to facilitate large transfers of data therebetween. In other examples, GPU 604 and CPU 602 have separate or onboard memory. Onboard memory may provide more rapid and dedicated memory access.

Additionally, memory subsystem 606 may include program data 616 with a CPU Buffer and a GPU buffer. GPU buffers may include display buffers configured for storage of frames for rendering, manipulation, and display of frames.

In one embodiment, the program code includes non-transitory instructions that when executed by the processor subsystem cause the processor subsystem to perform tasks which may include: calculations, and/or actuation of the sensor subsystem, user interface subsystem, and/or network/data interface subsystem. In some embodiments, the program code may be statically stored within the server 202 as firmware. In other embodiments, the program code may be dynamically stored (and changeable) via software updates. In some such variants, software may be subsequently updated by external parties and/or the user, based on various access permissions and procedures.

In one embodiment, the tasks are configured to: receive a framerate from one or more client device, set a render rate based on the frame rate, disable a VSync/render limiting setting to have the server application on the server 202 manage rendering timing, render frames based on the frame rate, send frames to a client device 204 (via the network/data interface subsystem 610); receive (via the network/data interface subsystem 610) and process pacing messages; adjust a render time based on the pacing messages.

Control and synchronization of frame rendering and timing by the server 202 may be performed by the execution (by CPU 602 and/or GPU 604) of program code stored in memory subsystem 606. In some examples, the program code includes a shared object library, application modification, or operating system modification to allow the server 202 to control the frequency and/or the timing of frame rendering based on data/messages from the client device 204. The data/messages from the client device 204 may be used by the server 202 to set and/or alter the frequency or timing of frame rendering. In some examples, an application runs (at least in part) on the GPU 604, with the application capturing frames directly from buffers of the GPU 604 to control frame rendering timing. In other examples, the GPU 604 is running more than one application and captures frames from each application via a shared object library, application code, the kernel, and/or the GPU driver. The shared object library, application code, the kernel, and/or the GPU driver may (artificially) throttle the render timing of the app based on the client device 204.

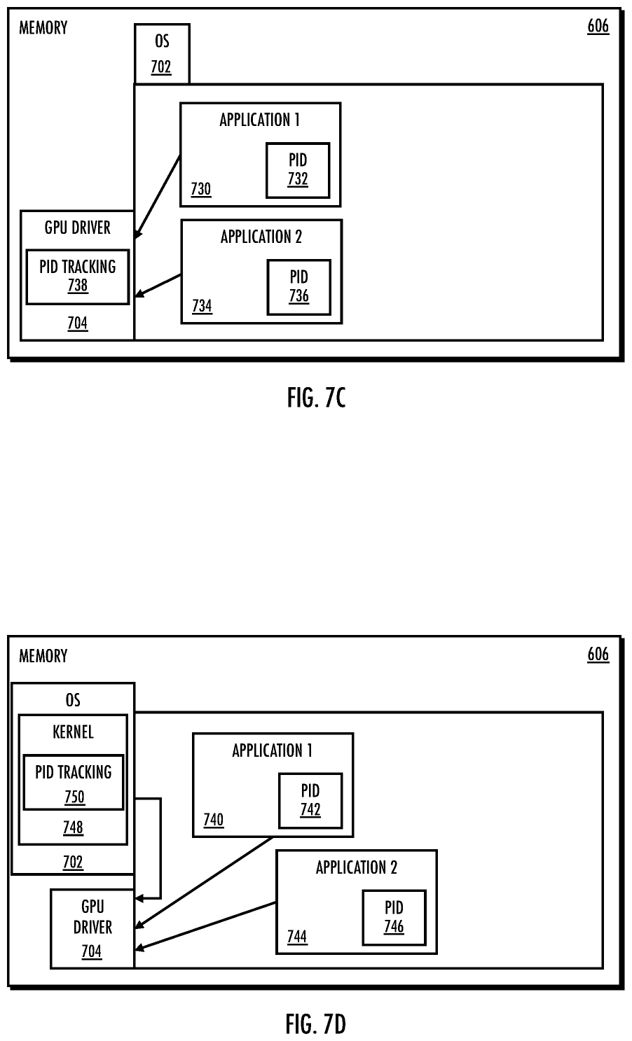

FIGS. 7A-7D illustrate exemplary memory subsystems 606 of the server 202 to allow the server 202 to control timing and frequency of frame rendering based on data from a client device 204. While illustrated as distinct approaches to control the timing and frequency of frame rendering on the server 202, combinations of the illustrated approaches may be used. Memory subsystem 606 includes an operating system 702 configured to control the scheduling and execution of applications and hardware of the server 202 and a GPU driver 704 configured to allow the operating system 702 and software applications on the server 202 to instruct/control the GPU 604.

FIG. 7A is a first exemplary logical block diagram of the memory subsystem 606 of the server 202. FIG. 7A illustrates the memory subsystem 606 with a first application 710 with a first shared object shim 712 (also known as a shared object library) and a second application 714 with a second shared object shim 716. The first shared object shim 712 is configured to optimize frame rendering frequency and timing for the first application 710 by communicating with the GPU driver 704 (which controls GPU 604). The second shared object shim 716 is configured to optimize frame rendering frequency and timing for the second application 714 by communicating with the GPU driver 704 (which controls GPU 604). Limiter code (such as code segment 1 and code segment 2) may be used with first shared object shim 712 for the first application 710 and the second shared object shim 716 for the second application 714 to adjust frame offsets/rendering timing of frames in each respective application. In some examples, the first application 710 and the second application 714 are different instances of the same application in communication with (and sets rendering frequency and timing based on) different client devices.

FIG. 7B is a second exemplary logical block diagram of the memory subsystem 606 of the server 202. FIG. 7B illustrates the memory subsystem 606 with an application 720 with embedded code 722. The embedded code 722 is configured to optimize frame rendering frequency and timing for the application 720 by communicating with the GPU driver 704 (which controls GPU 604). The embedded code 722 may include limiter code (such as code segment 1 and code segment 2) to adjust frame offsets/rendering timing of frames based on data received from (one or more) client device 204.

FIG. 7C is a third exemplary logical block diagram of the memory subsystem 606 of the server 202. FIG. 7C illustrates the memory subsystem 606 with a first application 730 having a first process identifier (PID) 732 and a second application 734 having a second PID 736. The GPU driver 704 may include PID tracking logic 738 to assign and track the first application 730 and the second application 734 based on their PID (first PID 732 and second PID 736, respectively). The GPU driver 704 may be configured to optimize frame rendering frequency and timing for the first application 730 (with first PID 732) by controlling the timing of frame rendering frequency and timing on the GPU 604 to correspond to data sent from a first client device. The GPU driver 704 may be configured to optimize frame rendering frequency and timing for the second application 734 (with second PID 736) by controlling the timing of frame rendering frequency and timing on the GPU 604 to correspond to data sent from a second client device. In some examples, the first application 730 and the second application 734 are different instances of the same application in communication with (and sets rendering frequency and timing based on) different client devices.

FIG. 7D is a fourth exemplary logical block diagram of the memory subsystem 606 of the server 202. FIG. 7D illustrates the memory subsystem 606 with a first application 740 having a first PID 742 and a second application 744 having a second PID 746. A kernel 748 in the operating system 702 may include PID tracking logic 750 to assign and track the first application 740 and the second application 744 based on their PID (first PID 742 and second PID 746, respectively). The kernel 748 may be configured to instruct the GPU driver 704 to optimize frame rendering frequency and timing for the first application 740 (with first PID 742) by controlling the timing of frame rendering frequency and timing on the GPU 604 to correspond to data sent from a first client device. The kernel 748 may be configured to instruct the GPU driver 704 to optimize frame rendering frequency and timing for the second application 744 (with second PID 746) by controlling the timing of frame rendering frequency and timing on the GPU 604 to correspond to data sent from a second client device. In some examples, the first application 740 and the second application 744 are different instances of the same application in communication with (and sets rendering frequency and timing based on) different client devices.

The server 202 may be connected to a display. The display may be integrated into server 202 via the bus and GPU 604 or may be connected to server 202 via an external display connector (e.g., HDMI, USB-C, VGA, Thunderbolt, DVI, DisplayPort, etc.). Frames are individual images of a sequence of images that are shown on the display. For example, a sequence of video images may be played at 24 frames per second (or 24 Hz) to create the appearance of motion and/or a game may be rendered and displayed at 60 frames per second (or 60 Hz). A refresh rate may reflect how often the display updates frames being shown. The display may include any suitable configuration for displaying one or more frames rendered by the server 202. For example, the display may include a liquid crystal display (LCD), touchscreen LCD (e.g., capacitive display), light emitting diode (LED) display, projector, or other display device to present information to a user of the server 202 in a visual display.

Still other variants may be substituted with equal success by artisans of ordinary skill, given the contents of the present disclosure.

### ADDITIONAL CONFIGURATION CONSIDERATIONS

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

As used herein any reference to any of “one embodiment” or “an embodiment”, “one variant” or “a variant”, and “one implementation” or “an implementation” means that a particular element, feature, structure, or characteristic described in connection with the embodiment, variant or implementation is included in at least one embodiment, variant or implementation. The appearances of such phrases in various places in the specification are not necessarily all referring to the same embodiment, variant or implementation.

As used herein, the term “computer program” or “software” is meant to include any sequence of human or machine cognizable steps which perform a function. Such program may be rendered in virtually any programming language or environment including, for example, Python, JavaScript, Java, C#/C++, C, Go/Golang, R, Swift, PHP, Dart, Kotlin, MATLAB, Perl, Ruby, Rust, Scala, and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die or distributed across multiple components.

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method of operating a client device in communication with a server, comprising:
synchronizing frame generation frequency with the server;
receiving a frame from the server; and
synchronizing frame generation timing with the server based on receiving the frame.

2. The method of claim 1, further comprising determining whether the frame was received or presented by the client device during a timing window.

3. The method of claim 2, where synchronizing frame generation timing comprises sending a pacing message to the server based on determining whether the frame was received or presented by the client device during a timing window.

4. The method of claim 3, where the pacing message comprises a timing offset.

5. The method of claim 3, where the pacing message comprises an instruction setting an earlier start time for rendering a next frame by the server.

6. The method of claim 3, where the pacing message is configured to cause the server to shift a timing of future frame rendering.

7. The method of claim 2, where the timing window is based on a presentation deadline of the frame.

8. The method of claim 2, where the timing window is based on a next vertical blanking interval.

9. The method of claim 1, further comprising:
processing the frame by the client device; and
displaying the frame at the client device.

10. The method of claim 1, where synchronizing frame generation frequency comprises:
determining a display frame rate; and
sending the display frame rate to the server.

11. The method of claim 1, further comprising:
rendering the frame by the client device; and
presenting the frame for display.

12. A non-transitory computer-readable medium comprising one or more instructions which, when executed by a processor, causes a device to:
determine a display refresh rate of the device;
send the display refresh rate to a server;
receive a frame from the server based on the display refresh rate;
present the frame for display at a time;
determine the time is outside a time window; and
send a pacing message to the server configured to shift a rendering time of a next frame based on the time being outside the time window.

13. The non-transitory computer-readable medium of claim 12, where the one or more instructions which, when executed by the processor, causes the device to:
receive a second frame from the server based on the pacing message;
present the second frame for display at a second time;
determine the second time is outside a second time window; and
send a second pacing message to the server configured to shift a second rendering time of a next frame based on determining the second time is outside the second time window.

14. The non-transitory computer-readable medium of claim 12, where determining the time is outside the time window is based on comparing the time with a presentation deadline minus a duration of a jitter window.

15. An apparatus, comprising:
a network interface;
a graphics processor;
a processor subsystem; and
a non-transitory computer-readable medium that stores instructions which when executed by the processor subsystem, causes the apparatus to:
receive a framerate from a client device via the network interface;
set a render frequency based on the framerate;
render a frame based on the render frequency;
send the frame to the client device via the network interface;
receive a pacing message from the client device via the network interface; and
adjust a rendering start time of a next frame based on the pacing message.

16. The apparatus of claim 15, where the instructions, when executed by the processor subsystem, cause the apparatus to disable a vertical synchronization setting.

17. The apparatus of claim 15, where the instructions, when executed by the processor subsystem, cause the apparatus to:
render the next frame based on the pacing message; and
sending the next frame to the client device via the network interface.

18. The apparatus of claim 15, where:
the pacing message comprises a timing offset, and
adjusting the rendering start time of the next frame is based on the timing offset.

19. The apparatus of claim 15, where the non-transitory computer-readable medium stores second instructions, when executed by the processor subsystem, cause the apparatus to:
receive a second framerate from a second client device via the network interface;
set a second render frequency based on the second framerate;
render a second frame based on the second render frequency;
send the second frame to the second client device via the network interface;
receive a second pacing message from the second client device via the network interface; and
adjust a second rendering start time of a second next frame based on the second pacing message.

20. The apparatus of claim 19, where:
the instructions are assigned a first process identifier,
the second instructions are assigned a second process identifier, and
the non-transitory computer-readable medium stores third instructions configured to control the graphics processor and track the first process identifier and the second process identifier to control differences in rendering frequency and rendering timing.
